(19) United States
(12) Patent Application Publication
(10) Pub. No.: US 2013/0242715 A1
(43) Pub. Date: Sep. 19, 2013

(54) OPTICAL PICKUP APPARATUS

(71) Applicant: Yasukazu IMAIZUMI, Ashikaga-shi (JP)

(72) Inventor: Yasukazu IMAIZUMI, Ashikaga-shi (JP)

(73) Assignee: SANYO ELECTRIC CO., LTD., Osaka (JP)

(21) Appl. No.: 13/608,073

(22) Filed: Sep. 10, 2012

(30) Foreign Application Priority Data
Sep. 9, 2011 (JP) 2011-197474

(51) Int. Cl. G11B 7/1275

(52) U.S. Cl. CPC G11B 7/1275
USPC 369/112.23

(57) ABSTRACT

An optical pickup apparatus includes: first and second laser diodes to generate first and second laser beams, respectively; a first holder, made of metal, to incorporate the first laser diode; a second holder, made of metal, to incorporate the second laser diode; an objective lens; optical elements to guide the first and the second laser beam to the objective lens; a housing made of synthetic resin to house the first and the second holders, the objective lens, and the optical elements such that the first and the second holders are adjacent to each other; and a first heat-transfer gel filled in a first space between the first and the second holders, so as to transfer heat generated in the first laser diode from the first holder to the second holder as well as transfer the heat generated in the second laser diode from the second holder to the first holder.

### CROSS-REFERENCE TO RELATED APPLICATION

This application claims the benefit of priority to Japanese Patent Application No. 2011-197474, filed Sep. 9, 2011, of which full contents are incorporated herein by reference.

### BACKGROUND OF THE INVENTION

1. Field of the Invention

The present invention relates to an optical pickup apparatus.

2. Description of the Related Art

In General, an optical pickup apparatus is known that is configured to condense a laser beam onto a signal recording layer of an optical disc to read information recorded in the optical disc (see, e.g., Japanese Laid-Open Patent Publication 2011-34643). This optical pickup apparatus includes: a first laser diode configured to generate a first laser beam having a first wavelength; and a second laser diode configured to generate a second laser beam having a second wavelength different from the first wavelength, in order to read the information stored in two types of optical discs of different standards, for example. The first laser diode and the second laser diode are respectively housed in a first holder and a second holder, made of metal, for example. The first holder and the second holder respectively have functions of dissipating the heat generated when the first laser diode and the second laser diode generate the laser beams, respectively. Thus, the first holder and the second holder are arranged in positions apart from each other inside a housing so as not to be affected by the heat dissipation of each other.

In the optical pickup apparatus disclosed in Japanese Laid-Open Patent Publication No. 2011-34643, it is preferable that the enough volumes of the first holder and the second holder are secured to dissipate the heat of the first laser diode and the second laser diode, respectively. If the first holder and the second holder are increased in volume to sufficiently secure the capability of dissipating the heat of the first laser diode and the second laser diode, the optical pickup apparatus is increased in size. Whereas, in the case of downsizing the optical pickup apparatus, the first holder and the second holder are required to be reduced in volume and there is a possibility of a shortage of the dissipating capability of the first holder and the second holder.

### SUMMARY OF THE INVENTION

An optical pickup apparatus according to an aspect of the present invention, includes: a first laser diode configured to generate a first laser beam having a first wavelength; a first holder made of metal configured to incorporate the first laser diode; a second laser diode configured to generate a second laser beam, having a second wavelength different from the first wavelength, in a manner complementary to the first laser beam; a second holder made of metal configured to incorporate the second laser diode; an objective lens configured to condense the first laser beam onto a signal recording layer of a first optical disc as well as condense the second laser beam onto the signal recording layer of a second optical disc of a standard different from that of the first optical disc; optical elements configured to guide the first laser beam and the second laser beam to the objective lens; a housing made of synthetic resin configured to house the first holder, the second holder, the objective lens, and the optical elements such that the first holder and the second holder are adjacent to each other; and a first heat-transfer gel filled in a first space between the first holder and the second holder, so as to transfer heat generated in the first laser diode from the first holder to the second holder as well as transfer the heat generated in the second laser diode from the second holder to the first holder.

Other features of the present invention will become apparent from descriptions of this specification and of the accompanying drawings.

### BRIEF DESCRIPTION OF THE DRAWINGS

For more thorough understanding of the present invention and advantages thereof, the following description should be read in conjunction with the accompanying drawings, in which:

FIG. 1 is a diagram illustrating a configuration of an optical system of an optical pickup apparatus according to a first embodiment of the present invention;

FIG. 2 is a diagram illustrating a configuration of a part of an optical system in an optical pickup apparatus according to a first embodiment of the present invention;

FIG. 3 is a block diagram illustrating an optical disc device in which a optical pickup apparatus according to a first embodiment of the present invention is used;

FIG. 4 is an exploded perspective view illustrating an optical pickup apparatus according to a first embodiment of the present invention;

FIG. 5 is an enlarged view illustrating a part of a housing in a first embodiment of the present invention;

FIG. 6 is a perspective view illustrating an optical pickup apparatus according to a first embodiment of the present invention;

FIG. 7 is a cross-sectional view of an optical pickup apparatus according to a first embodiment of the present invention; and

FIG. 8 is a cross-sectional view of an optical pickup apparatus according to another embodiment of the present invention.

### DETAILED DESCRIPTION OF THE INVENTION

At least the following details will become apparent from descriptions of this specification and of the accompanying drawings.

### First Embodiment

### ===Optical System of Optical Pickup Apparatus===

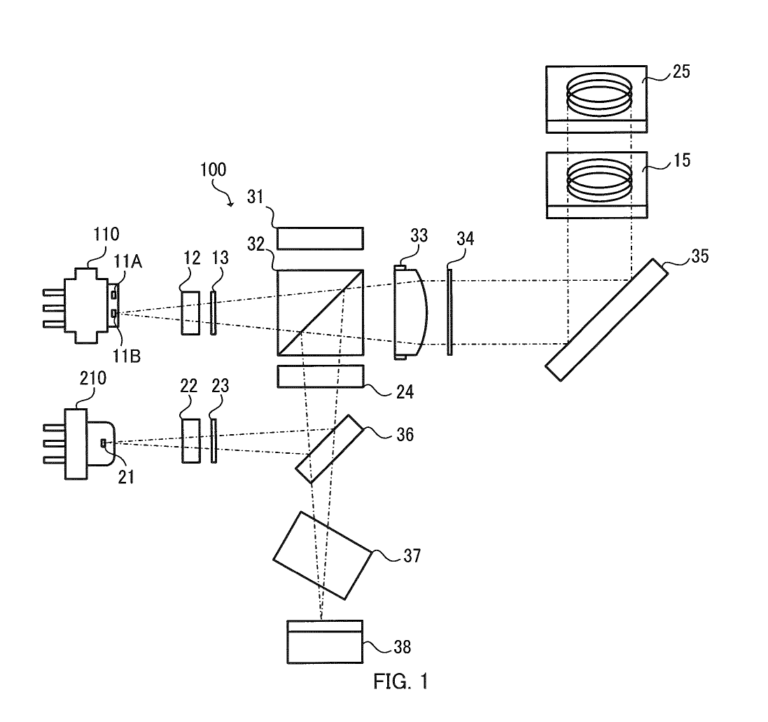

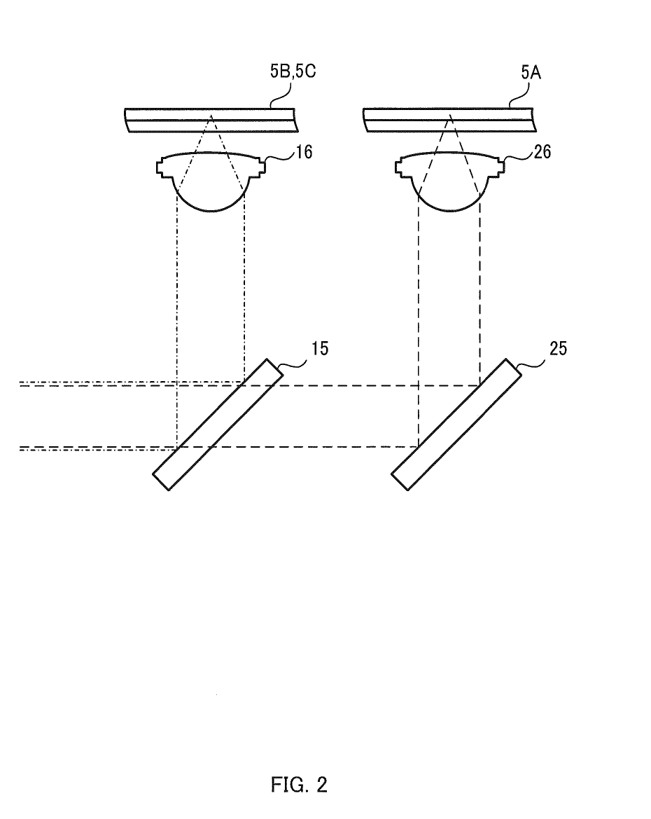

FIG. 1 depicts a configuration of an optical system of an optical pickup apparatus according to an embodiment of the present invention. FIG. 2 depicts a configuration of a part of an optical system of an optical pickup apparatus according to an embodiment of the present invention.

An optical pickup apparatus 100 is an apparatus configured to irradiate a rotating optical disc with a laser beam and detect return light of the laser beam reflected by the optical disc. The optical pickup apparatus 100 is mounted on an information recording and reproduction device, such as an optical disc device 500 which will be described later. The optical disc for which the information recording or reproduction is performed by the optical pickup apparatus 100 include the optical disc of BD (Blu-ray Disc) standard (hereinafter referred to as “first optical disc 5A”), the optical disc of DVD (Digital Versatile Disc) standard (hereinafter referred to as “second optical disc 5B”), the optical disc of CD (Compact Disc) standard (hereinafter referred to as “third optical disc 5C”), etc. The optical pickup apparatus 100 includes: a first optical system along the optical path of a first laser beam applied onto the second optical disc 5B and the third optical disc 5C; and a second optical system along the optical path of a second laser beam applied onto the first optical disc 5A. The first optical system and the second optical system will be described later in detail.

### ===First Optical System===

The first optical system of the optical pickup apparatus according to an embodiment of the present invention will hereinafter be described with reference to FIGS. 1 and 2.

The first optical system is an optical system for DVD standard and CD standard, and includes a first laser light source 110, a first diffraction grating 12, a first half-wave plate 13, a beam splitter 32, a collimating lens 33, a quarter-wave plate 34, a reflection mirror 35, a first raising reflection mirror 15, a first objective lens 16 (objective lens), a coupling lens 24, a semitransparent mirror 36, a detecting lens 37, a photodetector 38, and a front monitor diode 31. The first diffraction grating 12, the first half-wave plate 13, the beam splitter 32, the collimating lens 33, the quarter-wave plate 34, the reflection mirror 35, and the first raising reflection mirror 15 correspond to optical elements configuring the first optical system (hereinafter referred to as “optical elements of first optical system”).

The first laser light source 110 is configured to selectively generate the first laser beam having two different wavelengths, which are a wavelength of 655 nm, for example, in a red wavelength range (645 nm to 675 nm) wherein the second optical disc 5B is to be irradiated with the laser beam having a wavelength in this range; and a wave length of 785 nm, for example, in an infrared wavelength range (765 nm to 805 nm) wherein the third optical disc 5C is to be irradiated with the laser beam having a wavelength in this rage. The first laser light source 110 is formed incorporating, in a first holder 17, a first laser diode 11A configured to generate the first laser beam having a wavelength of 655 nm, for example, and a first laser diode 11B configured to generate the first laser beam having a wavelength of 785 nm, for example. The first holder 17 will be described later in detail.

The first diffraction grating 12 is configured to generate zero-order light, plus-first-order diffracted light, and minus-first-order diffracted light from the first laser beam generated in the first laser light source 110.

The first half-wave plate 13 is configured to convert the first laser beam, which is linearly-polarized light, into P-linearly-polarized light, for example.

The beam splitter 32 is configured to allow the P-polarized laser beam in the red wavelength range and the infrared wavelength range, for example, to pass therethrough and reflect the laser beam other than the P-polarized laser beam in the red wavelength range and the infrared wavelength range. The beam splitter 32 allows the P-polarized first laser beam in the red wavelength range or the infrared wavelength range incident from the first half-wave plate 13 to pass therethrough. At this moment, it is assumed that the beam splitter 32 reflects a part of the first laser beam in the direction of the front monitor diode 31 so as to adjust the intensity of the first laser beam. The front monitor diode 31 is an optical element configured to receive a part of the first laser beam from the beam splitter 32, to adjust the intensity of the first laser beam. Since the return light of the first laser beam incident from the collimating lens 33 has converted into the S-polarized laser beam by being reflected by the second optical disc 5B or the third optical disc 5C, for example, the beam splitter 32 reflects the return light of the first laser beam in the direction of the coupling lens 24.

The collimating lens 33 is configured to convert the first laser beam incident from the beam splitter 32 into parallel light.

The quarter-wave plate 34 is configured to convert the first laser beam incident from the collimating lens 33 from the linearly-polarized light into the circularly-polarized light. The quarter-wave plate 34 converts the return light of the first laser beam incident from the reflection mirror 35 from the circularly-polarized light into the linearly-polarized light.

The reflection mirror 35 is configured to reflect the first laser beam incident from the quarter-wave plate 34 in the direction of the first raising reflection mirror 15. The reflection mirror 35 is configured to reflect the return light of the first laser beam incident from the first raising reflection mirror 15 in the direction of the quarter-wave plate 34.

The first raising reflection mirror 15 is configured to reflect the first laser beam incident from the reflection mirror 35 in the direction perpendicular to a recording face of the second optical disc 5B or the third optical disc 5C. The first raising reflection mirror 15 is configured to reflect the return light of the first laser beam incident from the first objective lens 16 in the direction of the reflection mirror 35.

The first objective lens 16 is configured to condense the first laser beam incident from the first raising reflection mirror 15 onto a signal recording layer in the recording face of the second optical disc 5B or the third optical disc 5C.

The return light of the first laser beam reflected by the signal recording layer of the second optical disc 5B or the third optical disc 5C is converted into the parallel light by the first objective lens 16, thereafter enters the quarter-wave plate 34 via the first raising reflection mirror 15 and the reflection mirror 35, and is converted by the quarter-wave plate 34 from the circularly-polarized light into the linearly-polarized light. The return light of the first laser beam, which has been converted into the linearly-polarized light, enters the coupling lens 24 via the collimating lens 33 and the beam splitter 32.

The coupling lens 24 is configured to convert the convergence angle of the return light of the first laser beam incident from the beam splitter 32 so that the return light of the first laser beam can be received by the photodetector 38.

The semitransparent mirror 36 is configured to reflect the S-polarized laser beam in a blue wavelength range, and allow the laser beam other than the S-polarized laser beam in the blue wavelength range to pass therethrough, for example. The blue wavelength range will be described later in detail. The return light of the first laser beam incident from the coupling lens 24 is the S-polarized laser beam in the red wavelength range or the infrared wavelength range, and the semitransparent mirror 36 is configured to allow the return light of the first laser beam incident from the coupling lens 24 to pass there through.

The detecting lens 37 is configured to condense the return light of the first laser beam incident from the semitransparent mirror 36 onto the photodetector 38, as well as cause astigmatism in the return light of the first laser beam, thereby generating a focus error signal. On the incident surface side or the emitting surface side of the detecting lens 37, for example, a cylindrical surface, a flat surface, a concave curved surface, or a convex curved surface is formed, and in an embodiment of the present invention, the detecting lens 37 is configured such that a parallel plate is inclined in a predetermined direction considering the direction of occurrence of astigmatism.

The photodetector 38 is configured to perform a photoelectric conversion of the return light of the first laser beam incident from the detecting lens 37.

### ===Second Optical System===

The second optical system of the optical pickup apparatus according to an embodiment of the present invention will hereinafter be described with reference to FIGS. 1 and 2.

The second optical system is an optical system for BD standard, and includes a second laser light source 210, a second diffraction grating 22, a second half-wave plate 23, the semitransparent mirror 36, the coupling lens 24, the beam splitter 32, the collimating lens 33, the quarter-wave plate 34, the reflection mirror 35, a second raising reflection mirror 25, a second objective lens 26 (objective lens), the detecting lens 37, the photodetector 38, and the front monitor diode 31. For example, the semitransparent mirror 36, the coupling lens 24, the beam splitter 32, the collimating lens 33, the quarter-wave plate 34, the reflection mirror 35, the detecting lens 37, the photodetector 38, and the front monitor diode 31 are commonly used between the first optical system and the second optical system. The second diffraction grating 22, the second half-wave plate 23, the semitransparent mirror 36, the coupling lens 24, the beam splitter 32, the collimating lens 33, the quarter-wave plate 34, the reflection mirror 35, and the second raising reflection mirror 25 correspond to the optical elements configuring the second optical system (hereinafter referred to as “optical elements of second optical system”).

The second laser light source 210 is configured to generate, in a manner complementary to the first laser beam, the second laser beam having 405 nm wavelength, for example, in the blue wavelength range (400 nm to 420 nm) different from the wavelength of the first laser beam generated by the first laser light source 110, wherein the first optical disc 5A is to be irradiated with the laser beam having a wavelength in this range. The second laser light source 210 is formed incorporating, in a second holder 27, a second laser diode 21 configured to generate the second laser beam having a wavelength 405 nm, for example. The second holder 27 will be described later in detail.

The second diffraction grating 22 is configured to generate zero-order light, plus-first-order diffracted light, and minus-first-order diffracted light from the second laser beam generated in the second laser light source 210.

The second half-wave plate 23 is configured to convert the second laser beam, which is linearly-polarized light, into S-linearly-polarized light, for example.

The semitransparent mirror 36 is configured to reflect the S-polarized second laser beam in the blue wavelength range incident from the second half-wave plate 23 in the direction of the coupling lens 24. Since the return light of the second laser beam incident from the coupling lens 24 has been converted into the laser beam of the P-polarized laser beam by being reflected by the first optical disc 5A, for example, the semitransparent mirror 36 allows the return light of the second laser beam to pass therethrough.

The coupling lens 24 is configured to convert the divergence angle of the second laser beam incident from the semitransparent mirror 36 so that the second laser beam is condensed onto the signal recording layer of the first optical disc 5A. The coupling lens 24 is also configured to convert the convergence angle of the return light of the second laser beam incident from the beam splitter 32 so that the return light of the second laser beam can be received by the photodetector 38.

Since the second laser beam incident from the coupling lens 24 is the S-polarized laser beam in the blue wavelength range other than the P-polarized laser light in the red wavelength range and the infrared wavelength range, for example, the beam splitter 32 reflects the second laser beam incident from the coupling lens 24 in the direction of the collimating lens 33. At this moment, the beam splitter 32 allows a part of the second laser beam to pass therethrough so as to adjust the intensity of the second laser beam. The front monitor diode 31 is the optical element configured to receive a part of the second laser beam from the beam splitter 32, to adjust the intensity of the second laser beam. Since the return light of the second laser beam incident from the collimating lens 33 is the P-polarized laser beam in the blue wavelength range other than the P-polarized laser beam in the red wavelength range and the infrared wavelength range, for example, the beam splitter 32 reflects the return light of the second laser beam incident from the collimating lens 33 in the direction of the coupling lens 24.

The second laser beam reflected by the beam splitter 32 in the direction of the collimating lens 33 is converted into the parallel light by the collimating lens 33, and thereafter is converted by the quarter-wave plate 34 from the linearly-polarized light to the circularly-polarized light. The second laser beam, which has been converted into the circularly-polarized light, is reflected by the reflection mirror 35 in the direction of the second raising reflection mirror 25. It is assumed that the first raising reflection mirror 15 arranged between the reflection mirror 35 and the second raising reflection mirror 25 in the optical path of the second laser beam reflects the laser beam in the red wavelength range and the infrared wavelength range and allows the laser beam in the blue wavelength range to pass therethrough.

The second raising reflection mirror 25 is configured to reflect the second laser beam incident from the reflection mirror 35 in the direction perpendicular to the recording face of the first optical disc 5A. The second raising reflection mirror 25 reflects the return light of the second laser beam incident from the second objective lens 26 in the direction of the reflection mirror 35.

The second objective lens 26 is configured to condense the second laser beam incident from the second raising reflection mirror 25 onto the signal recording layer in the recording face of the first optical disc 5A.

The return light of the second laser beam reflected by the signal recording layer of the first optical disc 5A is converted into the parallel light by the second objective lens 26, thereafter enters the quarter-wave plate 34 via the second raising reflection mirror 25 and the reflection mirror 35, and is converted by the quarter-wave plate 34 from the circularly-polarized light into the linearly-polarized light. The return light of the second laser beam, which has been converted into the linearly-polarized light, enters the detecting lens 37 via the collimating lens 33, the beam splitter 32, the coupling lens 24, and the semitransparent mirror 36.

The detecting lens 37 is configured to condense the return light of the second laser beam incident from the semitransparent mirror 36 onto the photodetector 38, as well as cause astigmatism in the return light of the second laser beam, thereby generating the focus error signal.

The photodetector 38 is configured to perform the photoelectric conversion of the return light of the second laser beam incident from the detecting lens 37.

### ===Optical Disc Device===

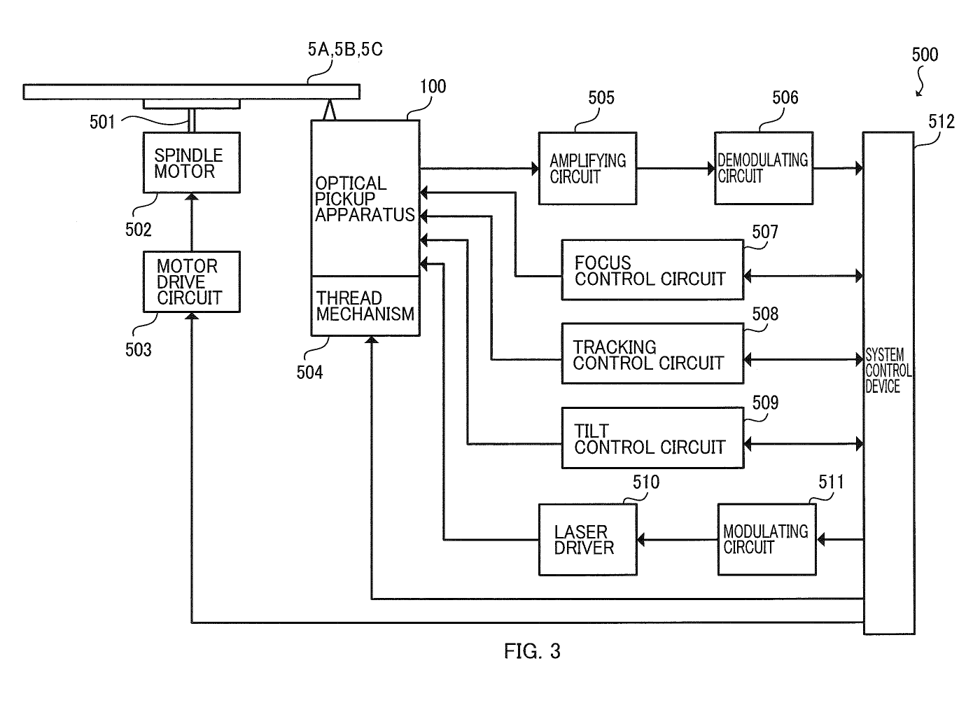

The optical disc device, in which the optical pickup apparatus according to an embodiment of the present invention is used, will hereinafter be described with reference to FIG. 3. FIG. 3 is a block diagram of the optical disc device in which the optical pickup apparatus according to an embodiment of the present invention is used.

An optical disc device 500 includes a spindle motor 502, a motor drive circuit 503, the optical pickup apparatus 100, a thread mechanism 504, an amplifying circuit 505, a demodulating circuit 506, a focus control circuit 507, a tracking control circuit 508, a tilt control circuit 509, a laser driver 510, a modulating circuit 511, and a system control device 512.

The spindle motor 502 is configured to rotate the optical disc 5 about a rotation axis 501. Out of the first optical disc 5A, the second optical disc 5B, and the third optical disc 5C, the optical disc rotated by the spindle motor 502 is referred to as the optical disc 5 for the sake of convenience.

The motor drive circuit 503 is configured to control the rotation of the spindle motor 502 in response to a control signal sent from the system control device 512.

The thread mechanism 504 includes a pulse-driven stepping motor, for example, and is configured to move the optical pickup apparatus 100 in the radical direction of the optical disc 5 in response to the control signal sent from the system control device 512.

The laser driver 510 is configured to control the output of the first laser beam and the second laser beam generated in the first laser diode 11A/11B and the second laser diode 21, respectively, in response to a signal inputted from the modulating circuit 511.

The modulating circuit 511 is configured to convert data, which is to be recorded in the optical disc 5 and is inputted from the system control device 512, into a pulse signal for recording. It is assumed that the data to be recorded in the optical disc 5 is supplied at any time from an external device (not shown) such as a personal computer via the system control device 512, for example.

The amplifying circuit 505 is configured to amplify an RF (Radio Frequency) signal contained in an electrical signal outputted from the photodetector 38 of the optical pickup apparatus 100, and output the amplified signal to the demodulating circuit 506.

The demodulating circuit 506 is configured to demodulate the RF signal inputted from the amplifying circuit 505, and output the demodulated signal to the system control device 512. The system control device 512 is configured to output, to the external device, a data signal based on the demodulated signal inputted from the demodulating circuit 506.

The focus control circuit 507, the tracking control circuit 508, and the tilt control circuit 509 perform drive control of the first objective lens 16 and the second objective lens 26 of the optical pickup apparatus 100.

### ===Optical Pickup Apparatus===

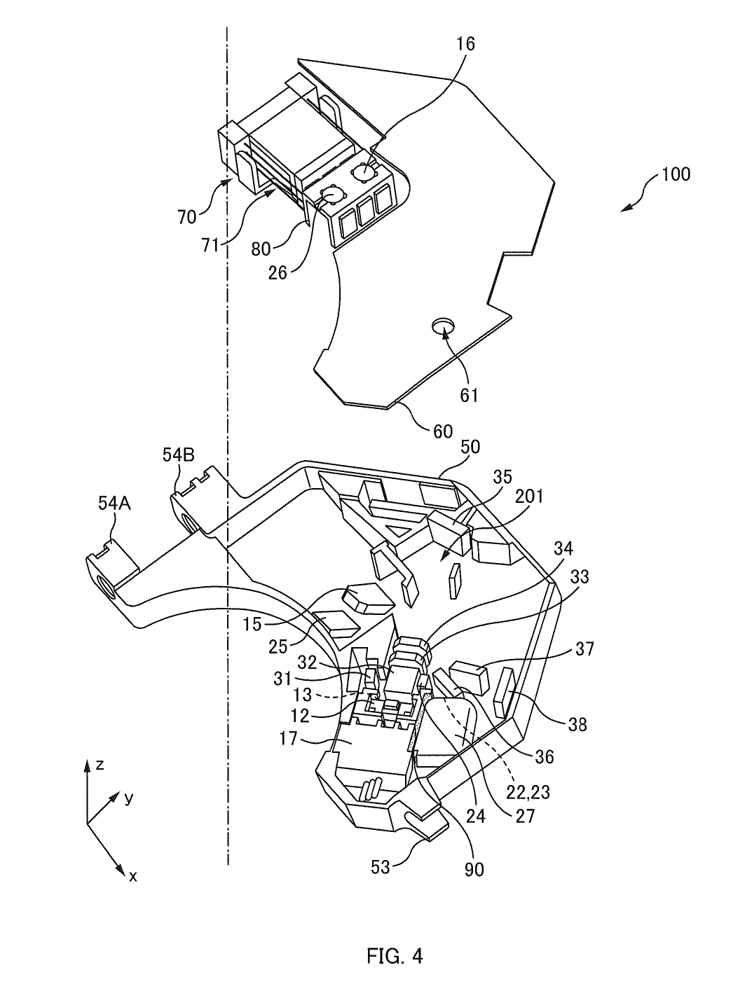

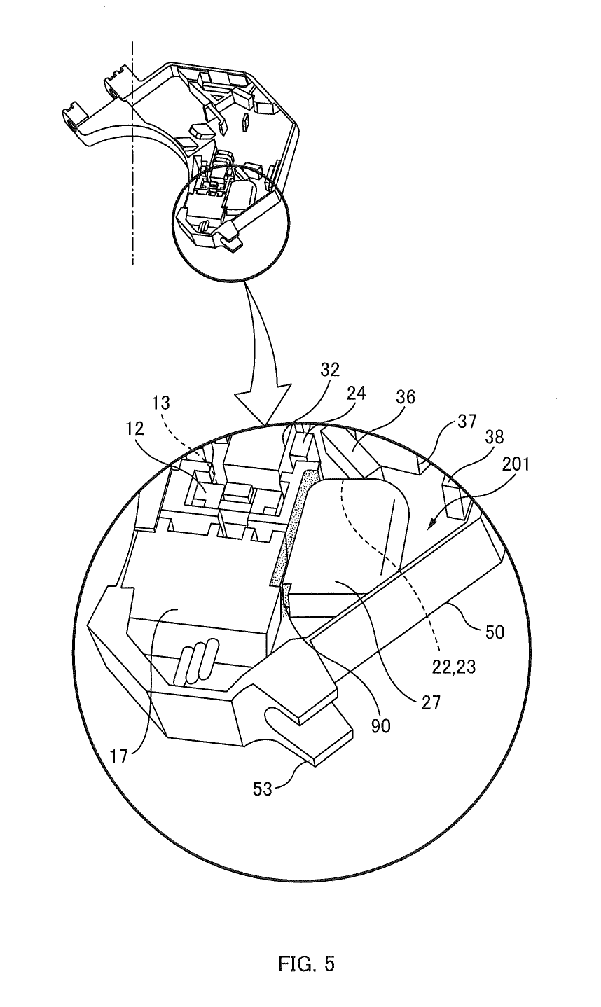

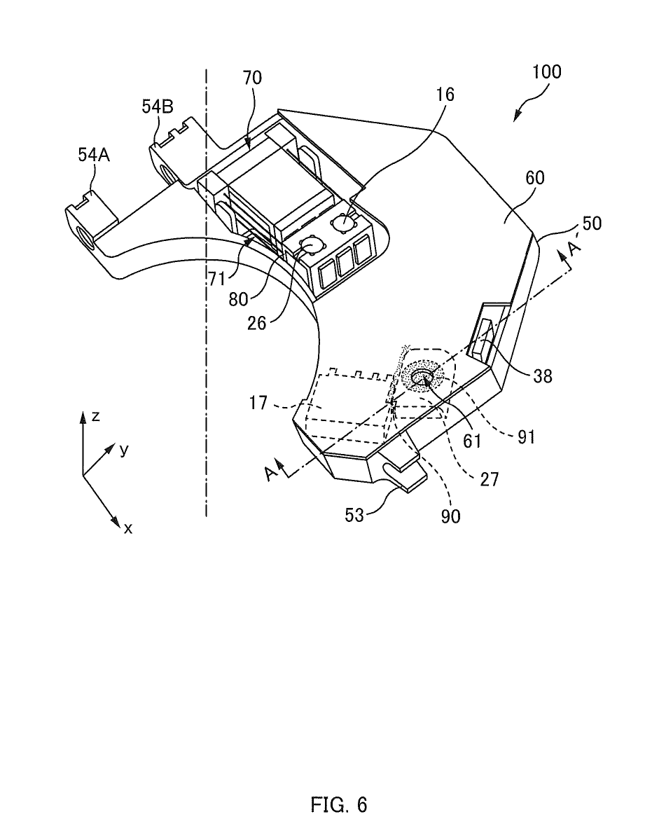

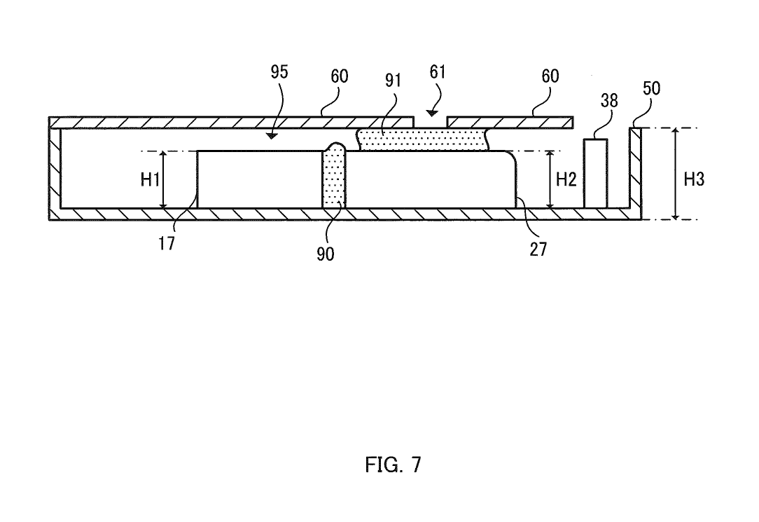

The optical pickup apparatus according to an embodiment of the present invention will hereinafter be described with reference to FIG. 1, FIG. 2, and FIGS. 4 to 7. FIG. 4 is an exploded perspective view of the optical pickup apparatus according to an embodiment of the present invention. The central axis of the rotation axis 501 of the spindle motor 502 is denoted by a dashed-dotted line for the convenience of description. The first half-wave plate 13, the second diffraction grating 22, and the second half-wave plate 23 are in an invisible state. FIG. 5 is an enlarged view of a part of a housing according to an embodiment of the present invention. The first half-wave plate 13, the second diffraction grating 22, and the second half-wave plate 23 are in the invisible state. FIG. 6 is a perspective view of the optical pickup apparatus according to an embodiment of the present invention. The central axis of the rotation axis 501 of the spindle motor 502 is denoted by the dashed-dotted line for the convenience of description. The first holder 17, the second holder 27, a first heat-transfer gel 90, and a second heat-transfer gel 91 are in the invisible state, but are denoted by a dotted line for the convenience of description. FIG. 7 is a cross-sectional view of the optical pickup apparatus as seen from the cross-section along the line A-A′ of FIG. 6 toward the other direction.

The optical pickup apparatus 100 includes a housing 50, a cover 60, an actuator 70, a lens holder 80, the optical elements of the first optical system, the optical elements of the second optical system, the first heat-transfer gel 90, and the second heat-transfer gel 91. In an embodiment of the present invention, the Z-axis is an axis along the longitudinal direction (vertical direction) of the rotation axis 501 of the spindle motor 502 to rotate the optical disc 5, wherein the direction going upward is given as +Z direction and the direction going downward is given as−Z direction. The Y-axis is an axis along the direction in which the optical pickup apparatus 100 is moved in the radial direction of the optical disc 5, wherein the direction (back side) away from the rotation axis 501 is given as +Y direction and the direction (front side) toward the rotation axis 501 is given as −Y direction. The X-axis is an axis along the tangential direction orthogonal to both the side faces of the housing 50, wherein the direction toward one side face is given as −X direction and the direction toward the other side face is given as +X direction.

The housing 50 is a case made of synthetic resin to house the optical elements of the first optical system, the optical elements of the second optical system, the first holder 17, the second holder 27, and the actuator 70. The first holder 17 and the second holder 27 will be described later in detail. The housing 50 has an opening 201 formed so as to arrange from the upper side, for example, and house, inside the housing 50, the optical elements of the first optical system, the optical elements of the second optical system, the first holder 17, the second holder 27, the first objective lens 16, and the second objective lens 26. The front side of the housing 50 is in a shape formed by hollowing out with a predetermined curvature to avoid the spindle motor, for example. Guide members 53, 54A, and 54B are disposed on both side faces of the housing 50. The guide members 53, 54A, and 54B are members to attach the optical pickup apparatus 100 to a pair of guide shafts for moving the optical pickup apparatus 100 along the radial direction of the optical disc 5. The guide member 53 is provided on one side face of the housing 50, for example. The guide members 54A and 54B are provided on the other side face of the housing 50, for example. In the opening 201, the optical elements of the first optical system, the optical elements of the second optical system, the first holder 17, the second holder 27, the first objective lens 16, and the second objective lens 26 are arranged to have such a positional relationship as described referring to FIGS. 1 and 2. The configuration in which the first laser diodes 11A and 11B and the second laser diode 21 are arranged in the housing 50 will be described later in detail.

In the lens holder 80, the first objective lens 16 and the second objective lens 26 are provided such that the first objective lens 16 and the second objective lens 26 are arranged above the first raising reflection mirror 15 and the second raising reflection mirror 25, respectively. The lens holder 80 is attached to an actuator frame so as to be capable of being displaced in the focus direction (Z-axis direction), the tracking direction (Y-axis direction), and the tilt direction, using a plurality of suspension wires 71 arranged on both sides of the lens holder 80. The actuator 70 is a device configured to drive the first objective lens 16 and the second objective lens 26 in the focus direction (Z-axis direction), the tracking direction (Y-axis direction), and the tilt direction so that the laser beam applied onto the optical disc 5 is focused on the signal recording layer of the optical disc 5, is caused to follow a signal track of the optical disc 5, and becomes perpendicular to the signal recording layer of the optical disc 5. The actuator 70 and the lens holder 80 are arranged in a left-side area as seen from the central axis of the rotation axis 501 toward the back side, for example, in the opening 201 of the housing 50. It is assumed that the lens holder 80 is in such a shape as to be opened downward so that the first objective lens 16 and the second objective lens 26 are arranged above the first raising reflection mirror 15 and the second raising reflection mirror 25, respectively, when the lens holder 80 is arranged in the opening 201.

The first laser diodes 11A and 11B are configured with the first laser light source 110, which is a multi-laser unit having a plurality of laser diodes housed in the same package, and this first laser light source 110 is a so-called frame type laser light source, with a synthetic resin package. The first laser light source 110 is housed in the housing 50 in a state where it is incorporated in the first holder 17. On the other hand, the second laser diode 21 is configured with the second laser light source 210, and is a so-called can-type laser light source housed in a metallic cylindrical package. The second laser light source 210 is housed in the housing 50 in a state where it is incorporated in the second holder 27. The laser diode selected to generate the first laser beam, out of the first laser diodes 11A and 11B, is referred to as a first laser diode 11 for the convenience of description. The first holder 17 is a fixing member made of metal that is composed of lead, aluminum, or an alloy thereof, having a function of dissipating the heat generated in the first laser diode 11 when generating the first laser beam. The second holder 27, similarly to the first holder 17, is a fixing member made of metal that is composed of lead, aluminum, or an alloy thereof, having a function of dissipating the heat generated in the second laser diode 21 when generating the second laser beam. The heat dissipating capability of the first holder 17 and the second holder 27 is determined mainly based on the volumes of the first holder 17 and the volume of the second holder 27. The volume of the first holder 17 and the volume of the second holder 27 will be described later in detail.

The first holder 17 and the second holder 27 are arranged in a right-side area as seen from the central axis of the rotation axis 501 toward the back side, for example, in the opening 201 of the housing 50. The first holder 17 and the second holder 27 are arranged in the opening 201 in a manner adjacent to each other. The first holder 17 is arranged in the opening 201 so that the side face on the rotation axis 501 side of the first holder 17 is along the part formed by hollowing out with the predetermined curvature of the housing 50, for example. The second holder 27 is arranged in the opening 201 of the housing 50 in such a manner that a part of the side face on the rotation axis 501 side of the second holder 27 is opposed to a part of the side face opposite to the side face on the rotation axis 501 side of the first holder 17, for example. The first holder 17 and the second holder 27 are adjacent to each other in the radial direction so that there can be a space between the first holder 17 and the second holder 27, At this moment, the optical path of the first and the second optical systems are sufficiently secured. The space between the first holder 17 and the second holder 27 corresponds to a first space.

The first heat-transfer gel 90 is a gel made by mixing metallic particles of aluminum, iron, etc., into silicon which is a main component, for example. The first heat-transfer gel 90 is filled in the first space so as to transfer the heat generated in the first laser diode 11 from the first holder 17 to the second holder 27 as well as transfer the heat generated in the second laser diode 21 from the second holder 27 to the first holder 17. It is assumed that the first heat-transfer gel 90 has viscosity enough to prevent the gel from spreading to an area other than the filled area at the time of filling the first space. The heat-transfer will be described later in detail.

The cover 60 is a flat plate, for example, made of metal such as stainless steel to cover the opening 201 of the housing 50 from the upper side of the housing 50. The cover 60 is in a shape along the area other than the area in which the actuator 70 and the lens holder 80 are arranged in the upper face of the housing 50 so as to cover the area other than the area in which the actuator 70 and the lens holder 80 are arranged in the opening 201, for example. The cover 60 is attached to the edge of the housing 50 by an adhesive (not shown), screws (not shown), etc., for example, in the state of covering the opening 201 from the upper side of the housing 50. It is assumed that the first holder 17 and the second holder 27 are arranged in the opening 201 so that the height H1 of the first holder 17 and the height H2 of the second holder 27 becomes lower than the height H3 of the edge of the housing 50 with the bottom face of the housing 50 used as a reference, for example. Accordingly, when the opening 201 of the housing 50 is covered by the cover 60, a space 95 is formed between the cover 60 and the first holder 17 and between the cover 60 and the second holder 27. This space 95 corresponds to a second space. A hole 61 is formed in the cover 60 at the position opposed to the second holder 27, for example. The hole 61 will be described later in detail.

The second heat-transfer gel 91 is the gel made by mixing metallic particles of aluminum, iron, etc., into silicon which is the main component similarly to the first heat-transfer gel 90, for example. The second heat-transfer gel 91 is filled in the space 95 so as to transfer the heat generated in either of the first laser diode 11 and the second laser diode 21 from at least either of the first laser diode 11 and the second laser diode 21 to the cover 60. The second heat-transfer gel 91 is filled in the space 95 of the housing 50 with the cover 60 attached thereto through the hole 61 formed in the cover 60. It is assumed that the second heat-transfer gel 91 has viscosity enough to prevent the gel from spreading to an area other than the filled area at the time of filling the space 95. The heat-transfer will be described later in detail.

### ===Volumes and Heat-Dissipation of First and Second Holders===

Description of the volume of the first holder 17, the volume of the second holder 27, and the heat-dissipation of the first laser diode 11 and the second laser diode 21 will hereinafter be made with reference to FIG. 1, FIG. 2, and FIGS. 4 to 7.

The first laser diode 11 generates heat when generating the first laser beam, as described above. The heat is generated by the current supplied to the first laser diode 11 when the first laser diode 11 generates the first laser beam, for example. The second laser diode 21, similarly to the first laser diode 11, generates heat when generating the second laser beam. The optical pickup apparatus 100 is required to dissipate heat in order to prevent the first laser diode 11 or the second laser diode 21 from being deteriorated by the heat generated by the first laser diode 11 or the second laser diode 21. As described above, the first laser diode 11 and the second laser diode 21 generate the first laser beam and the second laser beam in a manner complementary to each other, and generate heat. The total volume of the first holder 17 and the second holder 27 is assumed to be a volume capable of dissipating the heat generated in the first laser diode 11 to such an extent that the deterioration of the first laser diode 11 is suppressed as well as dissipating the heat generated in the second laser diode 21 to such an extent that the deterioration of the second laser diode 21 is suppressed (hereinafter referred to as “volume capable of suppressing deterioration of laser diode”). It is assumed that the above total volume is determined by an experiment, etc., for example.

Accordingly, for example, when the first laser diode 11 generates the first laser beam, the heat generated in the first laser diode 11 is transferred from the first laser diode 11 to the first holder 17, to be dissipated. The heat generated by the heat-dissipation of the first holder 17 is transferred from the first holder 17 to the second holder 27 via the first heat-transfer gel 90, to be dissipated. The heat generated by the heat dissipation of the second holder 27 is transferred to the cover 60 via the second heat-transfer gel 91, to be dissipated. On the other hand, for example, when the second laser diode 21 generates the second laser beam, the heat generated in the second laser diode 21 is transferred from the second laser diode 21 to the second holder 27, to be dissipated. The heat generated by the heat-dissipation of the second holder 27 is transferred from the second holder 27 to the first holder 17 via the first heat-transfer gel 90, to be dissipated, as well as is transferred from the second holder 27 to the cover 60 via the second heat-transfer gel 91, to be dissipated.

As described above, the first laser diode 11 generates the first laser beam having a wavelength of 655 nm, for example. The first laser diode 11 is incorporated in the first holder 17 made of metal. The second laser diode 21 generates the second laser beam having a wavelength of 405 nm different from the wavelength of the first laser beam, for example, in a manner complementary to the first laser beam. The second laser diode 21 is incorporated in the second holder 27 made of metal. The first objective lens 16 condenses the first laser beam onto the signal recording layer of the second optical disc 5B or the third optical disc 5C. The second objective lens 26 condenses the second laser beam onto the signal recording layer of the first optical disc 5A. The optical elements of the first optical system and the optical elements of the second optical system guide the first laser beam and the second laser beam, respectively, to the first objective lens 16 and the second objective lens 26, respectively. The first holder 17, the second holder 27, the first objective lens 16, the second objective lens 26, the optical elements of the first optical system, and the optical elements of the second optical system are housed in the housing 50 made of synthetic resin. The first holder 17 and the second holder 27 are adjacent to each other in the housing 50. The first heat-transfer gel 90 is filled in the first space between the first holder 17 and the second holder 27. The heat generated from the first laser diode 11 is transferred from the first holder 17 to the second holder 27, and the heat generated in the second laser diode 21 is transferred from the second holder 27 to the first holder 17. Accordingly, the heat generated in the first laser diode 11 and the heat generated in the second laser diode 21 can be dissipated to the first holder 17 and the second holder 27. Since the housing 50 is made of synthetic resin and is easy to mold, a compact optical pickup apparatus 100 can be provided. Since the housing 50 is made of synthetic resin, the optical pickup apparatus 100 can be reduced in weight.

The total volume of the first holder 17 and the second holder 27 is determined depending on the amount of heat generation of each of the first laser diode 11 and the second laser diode 21. Accordingly, for example, setting the total volume of the first holder 17 and the second holder 27 to the volume capable of suppressing the deterioration of the laser diodes enables reliable dissipation of the heat generated in the first laser diode 11 and the heat generated in the second laser diode 21, thereby being able to prevent the deterioration of the first laser diode 11 and the second laser diode 21. Both when dissipating the heat generated in the first laser diode 11 and dissipating the heat generated in the second laser diode 21, the heat can be dissipated to the first holder 17 and the second holder 27, and thus the volumes of the first holder 17 and the second holder 27 can be reduced, thereby being able to provide a compact optical pickup apparatus 100.

At least a part of the opening 201 of the housing 50, in which the first holder 17, the second holder 27, the first objective lens 16, the second objective lens 26, the optical elements of the first optical system, and the optical elements of the second optical system are exposed, is covered by the metal-made cover 60. At this moment, the space 95 is formed between the cover 60 and the first holder 17 and between the cover 60 and the second holder 27, for example. The second heat-transfer gel 91 is filled in the space 95 between the cover 60 and the second holder 27, for example. Accordingly, for example, the heat of the second holder 27 is dissipated to the cover 60. Therefore, the optical pickup apparatus 100 can be provided that has high capability of dissipating the heat generated in the first laser diode 11 and the heat generated in the second laser diode 21.

The hole 61 is formed in the cover 60 in the position opposed to the second holder 27, for example. Thus, for example, after the opening 201 of the housing 50 is covered by the cover 60, the second heat-transfer gel 91 can be filled in the space 95 between the cover 60 and the second holder 27 through the hole 61 of the cover 60. Therefore, with the hole 61 formed in the cover 60 in such a position that the second heat-transfer gel 91 can be reliably filled in the space 95, the second heat-transfer gel 91 can be reliably filled in the space 95 through the hole 61. Consequently, it is made possible to reliably dissipate the heat generated in the first laser diode 11 and the heat generated in the second laser diode 21.

The first holder 17 and the second holder 27 are arranged in the housing 50 along the radial direction. Thus, for example, in the case where the first holder 17 and the second holder 27 are arranged, in the radial direction, along the direction in which the optical pickup apparatus 100 is moved being guided by a pair of guide shafts, the width in the direction orthogonal to both the side faces of the housing 50 can be shortened, for example, thereby being able to provide a compact optical pickup apparatus 100.

The first holder 17 and the second holder 27 are arranged in the housing 50 so that parts of the faces will be opposed to each other in the radial direction. If parts of the faces of the first holder 17 and the second holder 27 are opposed to each other, then the first holder 17 and the second holder 27 can transfer the heat to each other via the first heat-transfer gel 90. Thus, it is not necessary to cause the entire area of the face opposed to the second holder 27 in the first holder 17 and the entire area of the face opposed to the first holder 17 in the second holder 27 to be opposed to each other, thereby enhancing the degree of freedom in design of the optical pickup apparatus 100 such as the arrangement of the optical elements with respect to the housing 50 and being able to provide the compact optical pickup apparatus 100.

### Other Embodiments

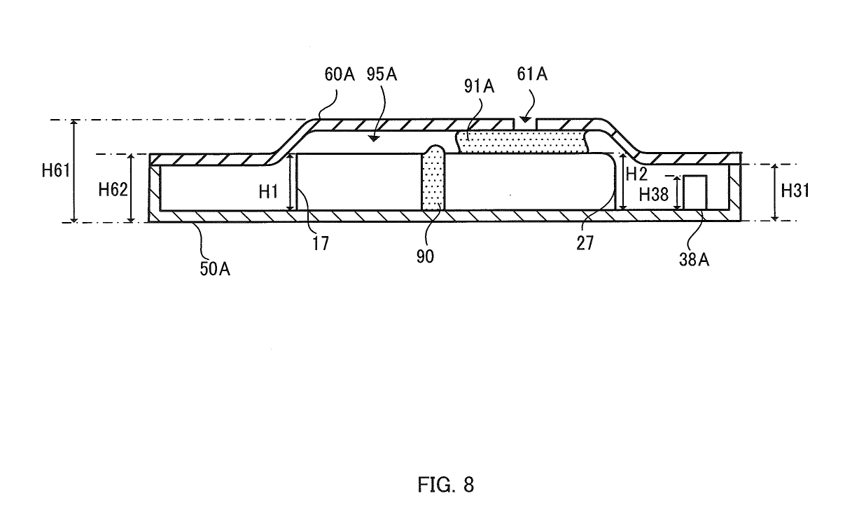

In a first embodiment of the present invention, a description has been given of the case where the first holder 17 and the second holder 27 are arranged in the housing 50 so that the height H1 of the first holder 17 and the height H2 of the second holder 27 becomes lower than the height H3 of the edge of the housing 50 with the bottom face of the housing 50 used as a reference and the cover 60 is in a flat plate shape, however, it is not limited thereto. For example, the first holder 17 and the second holder 27 may be arranged in a housing 50A so that the height H1 of the first holder 17 and the height H2 of the second holder 27 become substantially equal to or greater than the height H31 of the edge of the housing 50A with the bottom face of the housing 50A used as a reference, and a cover 60A may be in such a shape as to cover the first holder 17 and the second holder 27 from the upper side. Hereinafter, a description will be given, with reference to FIG. 8, of the case where the first holder 17 and the second holder 27 are arranged in the housing 50A so that the height H1 of the first holder 17 and the height H2 of the second holder 27 become equal to or greater than the height H31 of the edge of the housing 50A with the bottom face of the housing 50A used as a reference, and the cover 60A is in such a shape as to cover the first holder 17 and the second holder 27 from the upper side. FIG. 8 is a cross-sectional view of the optical pickup apparatus according to an embodiment of the present invention. Constituents equivalent to those shown in FIG. 7 are designated by the same reference numerals to omit the descriptions thereof. The first holder 17 and the second holder 27 are arranged in the housing 50A so that the height H1 of the first holder 17 and the height H2 of the second holder 27 become equal to or greater than the height H31 of the edge of the housing 50A with the bottom face of the housing 50A used as a reference. The cover 60A is a metal-made cover in such a shape as to cover the first holder 17 and the second holder 27 from the upper side. It is assumed that the height H61 of the part of the cover 60A that covers the first holder 17 and the second holder 27 is greater than the height H1 of the first holder 17 and the height H2 of the second holder 27 with the bottom face of the housing 50A used as a reference. It is also assumed that the height H62 of the part of the cover 60A other than the part that covers the first holder 17 and the second holder 27 is equal to or smaller than the height H1 of the first holder 17 and the height H2 of the second holder 27, with the bottom face of the housing 50A used as a reference. It is further assumed that the height H38 of a photodetector 38A is smaller than the height H62 of the part other than the part that covers the second holder 27, with the bottom face of the housing 50A used as a reference.

When the opening of the housing 50A is covered with the cover 60A, a space 95A is formed between the cover 60A and the first holder 17 and between the cover 60A and the second holder 27. A second heat-transfer gel 91A is filled in the space 95A through a hole 61A formed in the cover 60A in the position opposed to the second holder 27, for example. Thus, the heat generated in the first laser diode 11 or the second laser diode 21 is dissipated from the first holder and the second holder to the cover 60A via the second heat-transfer gel 91A. The height H31 of the edge of the housing 50A is equal to or smaller than the height Hi of the first holder 17 and the height H2 of the second holder 27, with the bottom face of the housing 50A used as a reference, and the height H62 of the part other than the part of the cover 60A that covers the first holder 17 and the second holder 27 is equal to or smaller than the height H1 of the first holder 17 and the height H2 of the second holder 27, with the bottom face of the housing 50A used as a reference, thereby being able to provide the compact optical pickup apparatus.

The above embodiments of the present invention are simply for facilitating the understanding of the present invention and are not in any way to be construed as limiting the present invention. The present invention may variously be changed or altered without departing from its spirit and encompass equivalents thereof.

In a first embodiment of the present invention, a description has been given of the configuration in which the second heat-transfer gel 91 is filled in the space 95 through the hole 61, however, it is not limited thereto. For example, the cover 60 may be attached to the housing 50 after the second heat-transfer gel 91 is heaped up on the top face of the first holder 17 and the second holder 27 so that the second heat-transfer gel 91 is filled in the space 95, without forming the hole 61 in the cover 60. In this case, a sufficient amount of the second heat-transfer gel 91 can be filled in the space 95 between the first holder 17 and the second holder 27, and the cover 60, thereby being able to provide the optical pickup apparatus 100 that has a high capability of dissipating the heat generated in the first laser diode 11 and the heat generated in the second laser diode 21. Further, it is not necessary to form the hole 61 in the cover 60 when manufacturing the optical pickup apparatus 100, thereby being able to reduce the manufacturing process and reduce the manufacturing cost of the optical pickup apparatus 100.

What is claimed is:

1. An optical pickup apparatus comprising:
a first laser diode configured to generate a first laser beam having a first wavelength;
a first holder made of metal configured to incorporate the first laser diode;
a second laser diode configured to generate a second laser beam, having a second wavelength different from the first wavelength, in a manner complementary to the first laser beam;
a second holder made of metal configured to incorporate the second laser diode;
an objective lens configured to condense the first laser beam onto a signal recording layer of a first optical disc as well as condense the second laser beam onto a signal recording layer of a second optical disc of a standard different from a standard of the first optical disc;
optical elements configured to guide the first laser beam and the second laser beam to the objective lens;
a housing made of synthetic resin configured to house the first holder, the second holder, the objective lens, and the optical elements such that the first holder and the second holder are adjacent to each other; and
a first heat-transfer gel filled in a first space between the first holder and the second holder, so as to transfer heat generated in the first laser diode from the first holder to the second holder as well as transfer the heat generated in the second laser diode from the second holder to the first holder.

2. The optical pickup apparatus of claim 1, wherein
a total volume of the first holder and the second holder is determined based on an amount of heat generation of the first laser diode and an amount of heat generation of the second laser diode.

3. The optical pickup apparatus of claim 1, comprising:
a cover made of metal configured to form a second space between the cover and at least one of the first holder and the second holder, in a state of covering an opening of the housing, the opening thereof having the first holder, the second holder, the objective lens, and the optical elements exposed therein; and
a second heat-transfer gel filled in the second space, so as to transfer, to the cover, heat generated in at least one of the first holder and the second holder.

4. The optical pickup apparatus of claim 3, wherein
the cover has a hole formed in an area in which the second space is formed, and wherein
the second heat-transfer gel is filled through the hole after the opening is covered with the cover.

5. The optical pickup apparatus of claim 1, wherein
the first holder and the second holder are arranged in a manner adjacent to each other in a radial direction.

6. The optical pickup apparatus of claim 5, wherein
the first holder and the second holder has faces opposed in part to each other in the radial direction.
